(19) United States
(12) Patent Application Publication
(10) Pub. No.: US 2007/0121333 A1
(43) Pub. Date: May 31, 2007

(54) Semiconductor light engine for automotive lighting

(76) Inventors: Ronald Woodward, Yorktown, VA (US); Ronald Gregory Hare, Belleville (CA); David J. Valcamp, Frankford (CA)

Correspondence Address: Mr. Robin W. Asher;Clark Hill PLC, Suite 3500, 500 Woodward Avenue, Detroit, MI, 48226-3435, US

(21) Appl. No.: 11/290,853

(22) Filed: Nov. 30, 2005

(51) Int. Cl. B60Q 1/00

(52) U.S. Cl. 362/459

(57) ABSTRACT

A light engine to provide light from a plurality of semiconductor light sources in an automotive lighting system, such as a headlamp, includes at least two substrates each of which has semiconductor light sources mounted thereon. The semiconductor light sources are spaced from one another on the substrates for cooling purposes. The substrates also preferably include at least one layer of heat transfer material which assists in transferring waste heat from the semiconductor light sources to a heat sink or other cooling means. The light engine further includes at least one transfer device comprising a bundle of light pipes, one light pipe for each semiconductor light source, and each light pipe has a receiving end which is located adjacent a respect one semiconductor light source and an emitter end which is located in close proximity to the emitter end of each other light pipe emitter end. The substrates can be located in a location which is convenient for the purposes of cooling the semiconductor light sources while the emitter end of the light pipes of the transfer device can be located adjacent a lens of the headlamp or other automotive lighting system. Further, the substrates can be stacked, one behind the other, with the light pipes passing through one substrate to receive light from semiconductor light sources on the other substrate.

### FIELD OF THE INVENTION

The present invention relates to a light source for automotive lighting systems and the like. More specifically, the present invention relates to a semiconductor light engine to provide light for automotive lighting systems and the like.

### BACKGROUND OF THE INVENTION

Automotive lighting systems, and in particular headlamp systems, require light sources capable of producing relatively bright light which can be formed into the necessary beam patterns, as defined and required by various safety regulations. Incandescent bulbs were employed as light sources for headlamp systems for many years with reasonably acceptable results.

To provide more light to improve the beam patterns produced by headlamp systems, quartz halogen (“Halogen”) and high intensity discharge (“HID”) bulbs are now commonly used instead of incandescent bulbs, as Halogen and HID bulbs produce significantly more light than incandescent bulbs. However, such Halogen and HID light sources suffer from disadvantages in that they create a significant amount of waste heat which the headlamp must be designed to withstand. Further, Halogen and HID headlamps require carefully designed optics to remove defects, from bulb filaments or bulb envelope influences, in the pattern of light they produce.

Accordingly, to withstand this heat and/or to provide the necessary optics, the enclosures of Halogen and HID headlamps must be relatively large and such large enclosures limit the aesthetic and/or aerodynamic designs which automotive designers could otherwise produce.

More recently, interest has developed in employing semiconductor light sources, such as light emitting diodes (“LED”s), as light sources for headlamp systems. LEDs which produce white light have become available and the amount of light produced by such LEDs has increased significantly in recent years. Ideally, headlamps employing LEDs as light sources will be able to be constructed with smaller enclosures than those required for conventional headlamps, allowing for the variety of aesthetic and aerodynamic vehicle designs to be increased.

However, LED-based headlamp systems also suffer from some disadvantages. The amount of light produced by available white LEDs is still insufficient to produce the required headlamp beam patterns and thus several closely positioned LEDs must be jointly employed to produce sufficient light. Further, the semiconductor junction in each LED produces a relatively large amount of waste heat when operating and this heat must be removed, by heat sinks, heat pipes and/or cooling fans and the like or the junction will fail. Thus, to provide for the proper arrangement of the multiple LED sources with respect to the lens of the LED headlamp and to provide adequate cooling of the LED sources, the enclosure of LED headlamps tend to be larger than is otherwise desired.

### SUMMARY OF THE INVENTION

It is an object of the present invention to provide a novel light engine which obviates or mitigates at least one disadvantage of the prior art.

According to a first aspect of the present invention, there is provided a light engine for an automotive lighting system, comprising: at least one substrate; a plurality of semiconductor light sources mounted to each of the at least one substrates, each adjacent semiconductor light source being spaced from each other adjacent semiconductor light source on the substrate to enhance cooling of the semiconductor light sources during operation thereof; and at least one a transfer device operable to receive light emitted by the semiconductor light sources on the at least one substrate and to transfer the received light to at least one location spaced from the substrate, wherein the transfer device comprises at least one light pipe, each light pipe having a receiving end to receive light emitted from a semiconductor light source and an emitting end to emit the received light.

### BRIEF DESCRIPTION OF THE DRAWINGS

Preferred embodiments of the present invention will now be described, by way of example only, with reference to the attached Figures, wherein:

FIG. 1 shows a schematic representation of a light engine in accordance with the present invention;

FIG. 2 shows a front view of a substrate and semiconductor light sources used in the light engine of FIG. 1;

FIG. 3 shows a side section taken along line 3-3 of FIG. 2;

FIG. 4 shows a section similar to that of FIG. 3 wherein one method of attaching light pipes to the semiconductor light sources of the substrate is shown;

FIG. 5 shows a front view of an emitter end of a transfer device of the light engine of FIG. 1;

FIG. 6 shows a side view of the emitter end of FIG. 5 and a portion of the bundle of light pipes of the light engine of FIG. 1;

FIG. 7 shows a front view of another embodiment of an emitter end of a transfer device of the light engine of FIG. 1;

FIG. 8 shows a mixer attached to the emitter end of a light pipe to provide a portion of diffuse light;

FIG. 9 shows a schematic representation of another embodiment of a light engine in accordance with the present invention; and

FIG. 10 shows a side view of another embodiment of a light engine in accordance with the present invention.

### DETAILED DESCRIPTION OF THE INVENTION

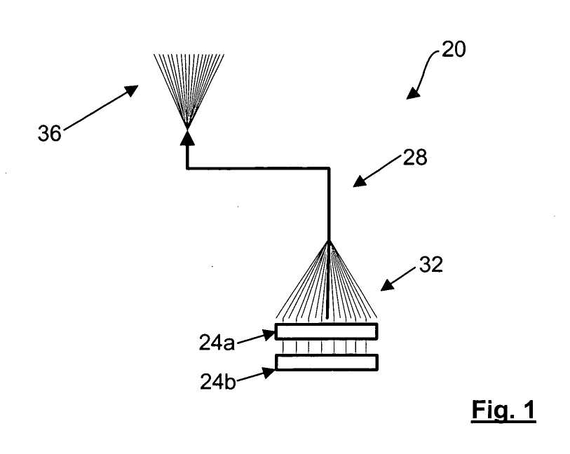

A first embodiment of a light engine in accordance with the present invention is indicated generally at 20 in FIG. 1. Light engine 20 includes two or more substrates 24a, 24b and a transfer device 28 which includes a receiving end 32 and an emitter end 36.

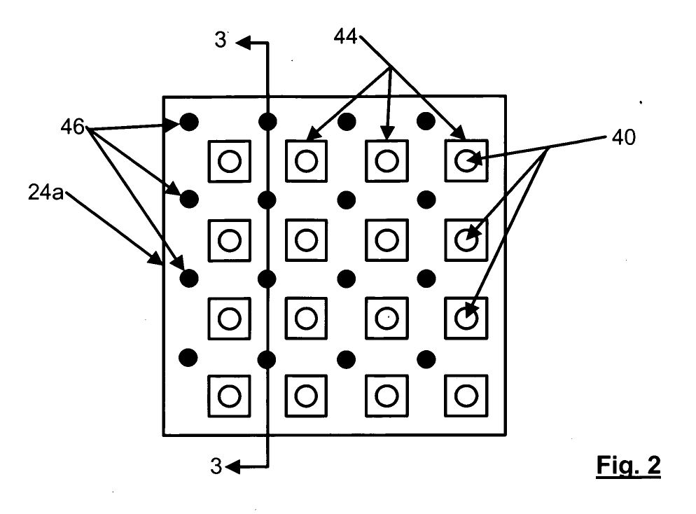

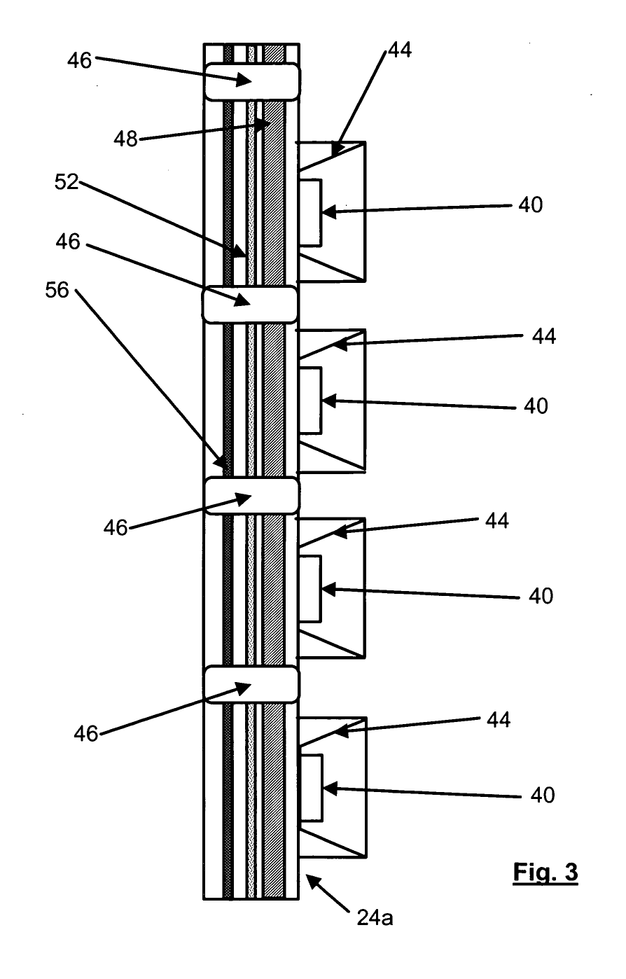

As shown in FIGS. 2 and 3, substrate 24a includes a plurality of semiconductor light sources 40, such as LEDs emitting white light, mounted thereon. Preferably, substrate 24a further includes a reflector 44 which surrounds each semiconductor light source 40 to direct the light emitted by each semiconductor light source 40 to the receiving end 32 of transfer device 28, as described in more detail below. Reflectors 44 are not essential to the operation of light engine 20, but can improve the efficiency of light engine 20. Substrate 24a preferably further includes a series of apertures 46, through substrate 24a, the purpose of which apertures 46 is discussed below.

Substrate 24b is substantially the same as substrate 24a but, if light engine 20 contains no additional substrates 24 to be stacked with substrate 24b or if substrates 24a or 24b are not to be stacked at all, then substrates 24a or 24b need not include apertures 46, but such apertures can be included in substrates 24a and 24b without harm, to allow for uniformity of manufacture of substrates 24.

Semiconductor light sources 40 are mounted to each substrate 24 with sufficient spacing between adjacent semiconductor light sources 40 to ensure that their junction temperatures can be maintained within the acceptable operating temperature range.

Substrates 24 can be formed of any suitable material as will be apparent to those of skill in the art and examples of such materials include ceramics, such as those used in packaging semiconductor integrated circuits, phenolics and/or epoxies, such as those used to fabricate printed circuit boards, etc.

Preferably, substrates 24 include at least one layer 48 of a heat transfer material, such as copper or aluminum, which assists in the removal of waste heat generated within semiconductor light sources 40. Layer 48 can be connected to a suitable heat sink, heat pipe or heat wick when substrates 24 are mounted in a headlamp system. Layer 48, in combination with the above mentioned spacing of semiconductor light sources 40 on substrates 24, ensures that semiconductor light sources 40 can be operated within their specified operating temperature range.

By employing more than one substrate 24 on which to mount semiconductor light sources 40, the necessary number of semiconductor light sources 40 to provide the desired amount of illumination from light engine 20 can be spaced across the faces each substrate 24, which are separated from each other substrate 24. In this manner, a less dense arrangement of semiconductor light sources 40 on each substrate 24 can be obtained to enhance cooling of the junctions of semiconductor light sources 40.

Each substrate 24 also preferably includes at least two electrical layers 52 and 56, each being a respective one of a positive and negative electrical conductor to which semiconductor light sources 40 are connected and are powered thereby. Alternatively, positive and negative electrical conductors can be provided as conductive traces on the top, bottom or both of the top and bottom of substrate 24.

It is contemplated that it may be desired to illuminate semiconductor light sources 40 in groups, for example to form low beam or high beam lighting patterns. In such case additional electrical conductors, whether in the form of conducting layers in substrate 24, conducting traces on the top or bottom of substrate 24, etc. can be provided to supply energy to such groups of semiconductor light sources 40.

Each reflector 44 preferably includes a parabolic shaped surface which surrounds its respective semiconductor light source 40 and reflectors 44 can be fabricated from any suitable material, such as acrylic, epoxy or polycarbonate, to which a suitable reflective coating can be applied or reflectors 44 can be fabricated from a reflective material such as aluminum.

In the illustrated embodiment, each reflector 44 is shown as being a separate component mounted to a substrate 24 individually, but it is also contemplated that reflectors 44 can be fabricated as a unit. For example, reflectors 44 can be molded as an assembly from an epoxy material, to which a reflective material is then applied, and the assembly being mounted to a substrate 24, over semiconductor light sources 40, after semiconductor light sources 40 have been mounted to substrate 24.

Similarly, reflectors 44 can be machined and polished as an assembly from a piece of aluminum, or the like, and then mounted to substrate 24. In this latter case, the assembly of reflectors 44 can also assist in the removal of waste heat produced by semiconductor light sources 40.

As shown in FIGS. 1, 4 and 6, transfer device 28 comprises at least one light pipe 60, such as fiber optic cable, light guides manufactured from polycarbonate or silicone rubber or moldable acrylic resins, such as Acrymid™ 815, sold by CYRO Industries of Rockaway, N.J., or any other suitable method of transferring light from a light source to a desired location. In a present embodiment, at least one light pipe 60 is provided for each semiconductor light source 40 but it is also contemplated that in some circumstances one light pipe 60 may be provided for two or more light sources 40.

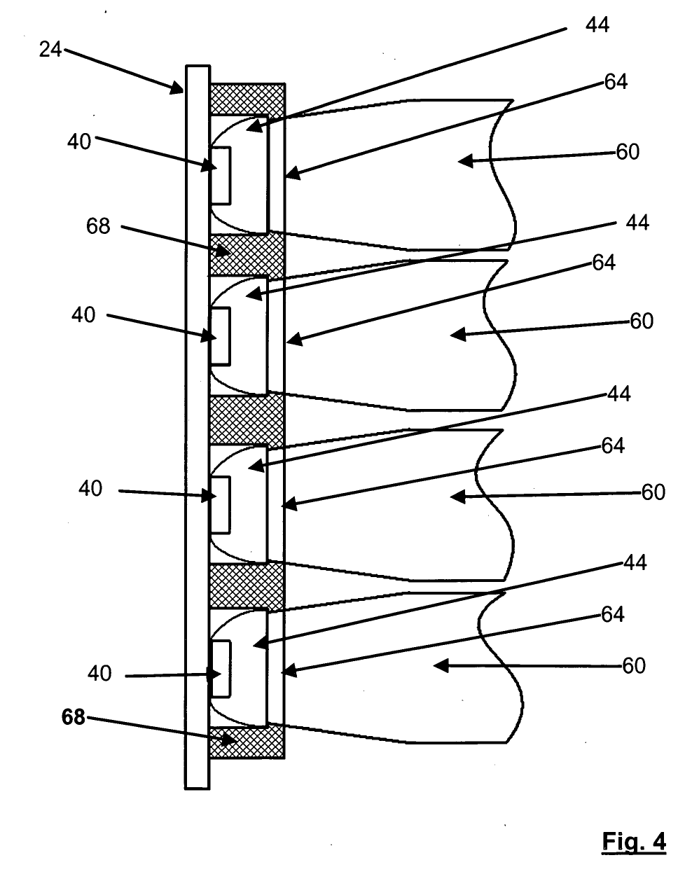

At receiving end 32 of transfer device 28, best shown in FIG. 4, each respective light pipe 60 is positioned adjacent a respective semiconductor light source 40 and reflector 44 (if present). In the embodiment of FIG. 1, some of light pipes 60 extend through apertures 46 in substrate 24a such that the ends of those light pipes can be positioned adjacent a respective semiconductor light source 40 and reflector 44 (if present) on substrate 24b.

Preferably, the receiving ends of the light pipes 60 include surfaces 64 which are shaped and positioned with respect to semiconductor light sources 40 on each substrate to capture a substantial portion of the light emitted by semiconductor light sources 40. The receiving ends of the light pipes are maintained in place by any suitable means, such as epoxy 68 or by mechanical means (not shown).

Preferably, the receiving ends of the light pipes are tapered, from a geometry (size and shape) substantially corresponding to the geometry of the outer end of reflector 44 (if present) or substantially corresponding to the geometry of semiconductor light source 40 (if no reflector 44 is present) to a larger geometry along the length of light pipe 60 to emitter end 36. As will be understood by those of skill in the art, such a taper will improve the amount of the light, emitted by semiconductor light source 40, which is received by the respective light pipe 60 and transmitted along its length.

As will also be understood by those of skill in the art, the length of light pipe 60 need not have the same cross-sectional shape as the receiver end of light pipe 60, for example the receiver end of light pipe 60 can have a rectangular geometry, in cross section, to correspond to the semiconductor light source while the length of light pipe 60 can be circular in cross-sectional shape, etc.

While in the illustrated embodiment substrates 24a and 24b are shown as being planar, the present invention is not so limited and either or both substrates 24 can include a curved surface, etc. if required to fit within a headlamp system with a small, or irregular, volume. In such a case, the length of the light pipes 60 in transfer device 28 may not all be the same.

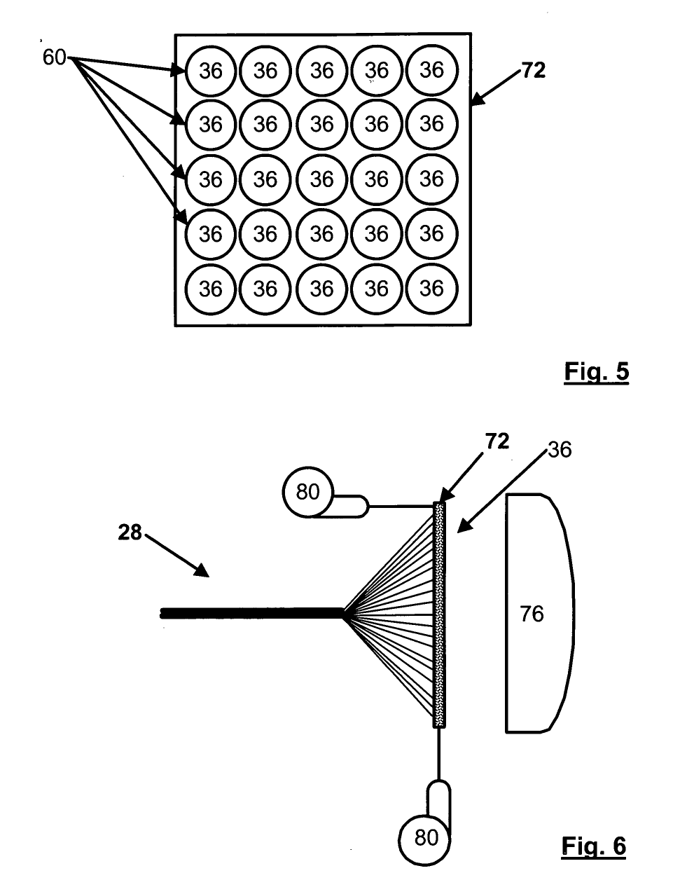

As shown in FIGS. 5 and 6, emitting end 36 of transfer device 28 preferably includes a forming member 72 which maintains the emitting ends of each light pipe 60 in their desired configuration. It is contemplated that in many circumstances the emitting ends of light pipes 60 will be maintained in a closely spaced configuration and substantially aligned, such that the light emitted from each light pipe 60 is substantially parallel to the light emitting by each other light pipe 60, but such a configuration is only one of many possible configurations of emitting end 36 of transfer device 28.

Forming member 72 can be an epoxy member cast about the ends of the light pipes 60 in transfer device 28, or can be a phenolic or epoxy board, aluminum sheet, etc. with suitably sized apertures to receive and maintain the respective ends of light pipes 60 in their desired configuration. As will be apparent, forming member 72 need not hold the individual light pipe ends of emitting end 36 in a planar arrangement and can instead hold the individual light pipe ends in convex, concave or another arrangement as might be desired.

Forming member 72 can also be used as a mounting member to retain emitter ends 36 in a desired position with respect to a lens system 76, or other component, within a headlamp system or the like. It is contemplated that forming member 72 can be mechanically mounted to one or more stepper motors 80, or other devices, to allow forming member 72 and the emitter ends of light pipes 60 to be moved with respect to lens system 76 to, for example, alter the emitted beam pattern and/or to compensate for loading and/or pitch or roll of a vehicle.

While not illustrated, it is also contemplated that light pipes 60 at emitting end 36 can taper from the above-mentioned larger geometry of the majority of their run length to a geometry which is smaller and/or a different cross sectional shape at their ends adjacent forming member 72 to increase the amount of light emitted from each light pipe 60.

As will be apparent, the spacing between the emitting ends of light pipes 60 can be much closer than the spacing of semiconductor light sources 40 on substrates 24. Thus, transfer device 28 allows semiconductor light sources 40 to be spaced and or located, on one or more substrates 24, to meet thermal requirements and yet allows the light emitted by semiconductor light sources 40 to be provided to a headlamp lens system in a much closer spaced configuration.

Further, the arrangement of emitter ends 36 of light pipes 60 in forming member 72 need not be the same as the arrangement of the receiving ends 32 of light pipes 60 at substrates 24. For example, light pipes 60 whose receiving ends 32 are located by adjacent semiconductor light sources 40 on a substrate 24 can be located non-adjacently on forming member 72. It is contemplated that this non-symmetry of the arrangement of the receiving ends 32 and emitter ends 36 of light pipes 60 provides numerous advantages.

For example, if light engine 20 includes a first set of semiconductor light sources 40 which are only illuminated to form a portion of a low beam headlamp pattern and a second set of semiconductor light sources 40 which are only illuminated to form a portion of a high beam headlamp pattern, the semiconductor light sources 40 in the first set can be mounted intermixed with the semiconductor light sources 40 of the second set, on one or both of substrates 24a and 24b. As only one set of semiconductor light sources 40 is illuminated at a given time, the spacing provided by the non-illuminated, but intermixed, semiconductor light sources 40 of the other set help reduce the thermal density of the waste heat produced by the operating semiconductor light sources 40.

In addition, by having differing arrangements of the emitter ends 36 and receiver ends 32 of light pipes 60, substrates 24 can be fabricated in different shapes to make better use of available space in a vehicle or other location. For example, while many headlamp beam patterns are substantially rectangular in shape, with the major axis of the rectangle being generally horizontal, substrates 24 can be square, round, rectangular, elliptical, irregular or any other shape which is desired. Further, substrates 24 can be oriented in any orientation which provides for efficient or desired use of the available volume for a headlamp or other vehicle lighting system using light engine 20.

Another contemplated advantage of light engine 20 is that, while receiving ends 32 of light pipes 60 preferably have a cross section which is selected to enhance the capture of the light emitted by their respective semiconductor light sources 40, the cross section and other characteristics of the emitter ends 36 can be varied as desired. For example, in some illumination patterns, such as a low beam headlamp pattern, sharp transitions or gradients between lighted and unlighted portions of the beam pattern are undesired.

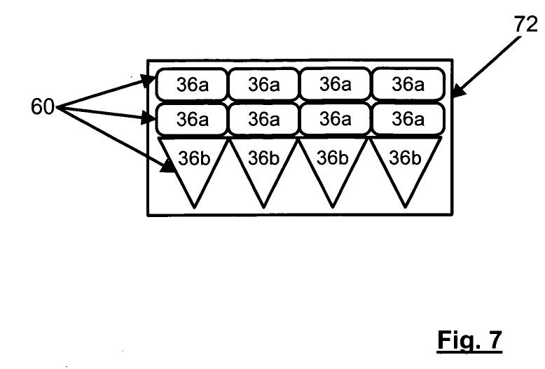

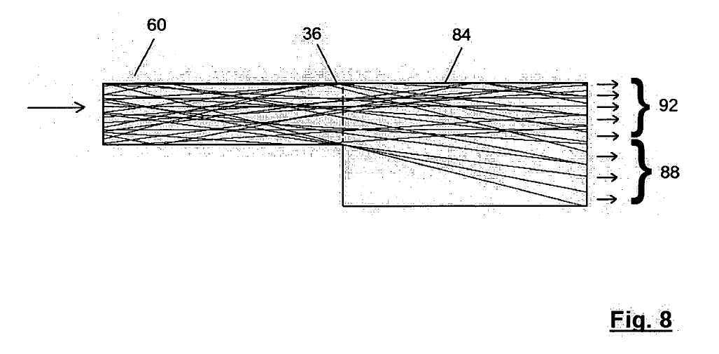

Accordingly; FIG. 7 shows another embodiment of the emitter end 36 of lights pipes 60 in transfer device 28 wherein some of the emitter ends 36a are generally rectangular in shape and other emitter ends 36b are generally triangular in shape to provide a gentler transition from lighted to unlighted parts of the resulting beam pattern. As will be apparent to those of skill in the art, a variety of other relative sizes, shapes and combinations of shapes can be employed for emitter ends 36. Similarly, emitted ends 36 can be located on forming member 72 with varying spacing to provide a desired varying density of illumination.

It is also contemplated that, if desired, emitter ends 36 can be treated to obtain desired beam pattern effects. Such treatments can include coatings applied to emitter ends 36 to diffuse their emitted light and/or other treatments as will occur to those of skill in the art.

FIG. 8 shows a mixer 84 which can be attached to, or integrally formed with, emitter ends 36 of light pipes 60. Mixer 84 can be fabricated from the same, or a different, material than light pipes 60 provided only that its refractive index is similar to the refractive index of light pipes 60. As shown, mixer 84 has at least one cross sectional dimension which is larger than the cross sectional dimensions of emitter end 36, resulting in an additional surface area 88 from which light from light pipe 60 will be emitted. As will be apparent, due to the internal reflection of the light rays in mixer 84, light emitted from surface area 88 of mixer 84 will be more diffuse than the light emitted from the surface area 92 of mixer 84 that corresponds to the cross section of emitter ends 36.

It is contemplated that a single mixer 84 can have two or more emitter ends 36 connected to it, or that an emitter end 36 can have its own mixer 84 connected to it to provide diffuse light, as needed, for forming a desired beam pattern.

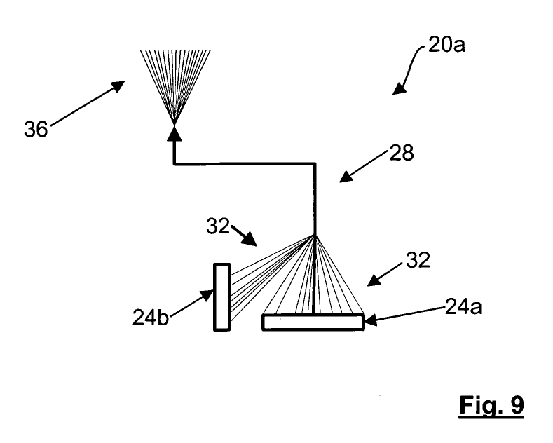

FIG. 9 shows another embodiment of a light engine 20a in accordance with the present invention. In this Figure, elements which are similar to those described above with reference to FIGS. 1 through 6 are indicated with like reference numerals. In light engine 20a, substrate 24a need not include apertures 46 as substrate 24b is located adjacent substrate 24a, rather than under it. As is illustrated, the receiving ends 32 of light pipes 60 of transfer device 28 extend, respectively, to semiconductor light sources 40 on each of substrates 24a and 24b. As should now be apparent, light engine 20a affords a great amount of flexibility in the size and positioning of substrates 24 to allow light engine 20a to be manufactured to fit within a wide variety of volumes on vehicles, or other desired locations.

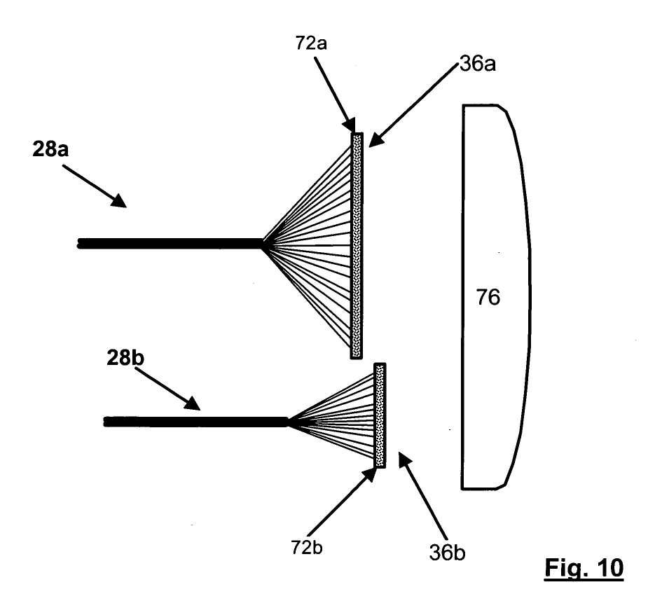

FIG. 10 shows yet another embodiment of a light engine 20b in accordance with the present invention. In this Figure, elements which are similar to those described above with reference to FIGS. 1 through 6 are indicated with like reference numerals. In light engine 20b, two transfer devices 28a and 28b are provided, each having a respective emitting end 36a and 36b, and a respective forming member 72a and 72b. The receiver end (not shown) of each transfer device 28a and 28b can be supplied with light from the same substrate (also not shown) or different substrates, as required.

In the illustrated embodiment, emitter ends 36a and 36b, and their respective forming members 72a and 72b are located at different distances from lens system 76. Assuming that emitter ends 36a are at the focal point of lens system 76, focused light will be provided from emitter ends 36a and transfer device 28a. If emitter ends 36b are located outside the focal point of lens system 76, unfocussed (diffuse) light will be provided from emitter ends 36b and transfer device 28b.

It is also contemplated that emitter ends 36a and 36b can be located at different distances and/or orientations with respect to lens system 76 and that one or more additional optical elements, such as mixer plates, diffusers, lenses, etc., can be interposed between one or the other or both of emitter ends 36a and 36b to alter the beam pattern produced by lens system 76 as desired and, for example, to simultaneously provide focused and diffuse beam patterns.

As should now be apparent to those of skill in the art, a light engine in accordance with the present invention provides several advantages for semiconductor-based headlamps. In prior art semiconductor headlamp systems, the semiconductor light sources had to be located adjacent the lens of the headlamp system to form the desired beam patterns. Electrical connections and heat removal systems thus had to be designed and arranged to work with the location of the light sources and the resulting heat transfer characteristics would often be less efficient than desired while the overall enclosure size and/or shape for the headlamp system would also be less favorable than desired.

In contrast, with a light engine in accordance with the present invention, transfer device 28 removes the need for the semiconductor light sources themselves to be located at any specific location with respect to the lens of the headlamp system. Instead, emitter end 36 of transfer device 28 can be appropriately positioned with respect to the lens, but one or more substrates 24, with semiconductor light sources 40 and the required electrical and heat transfer connections thereto, can be located in a variety of locations within the enclosure of the headlamp system. For example, a substrate 24 can be located horizontally along the bottom of a headlamp enclosure and another substrate 24 “stacked” behind it while emitter end 36 of transfer device 28 is located at the front of the headlamp enclosure, adjacent the lens. In such a configuration, each substrate 24 can be thermally connected to one or more heat sinks which extend from the bottom of the headlamp enclosure, etc.

Further, light engine 20 can be used as a standard light engine from which a wide variety of headlamp or other lighting systems can be constructed. Light engine 20 provides a known amount of light and a headlamp system can employ one or more light engines 20, as needed, to produce a required lighting level. By producing standardized light engines 20, manufacturing costs can be reduced, design processes simplified and repair of headlamp systems simplified.

The above-described embodiments of the invention are intended to be examples of the present invention and alterations and modifications may be effected thereto, by those of skill in the art, without departing from the scope of the invention which is defined solely by the claims appended hereto.

We claim:

1. A light engine for an automotive lighting system, comprising:
at least one substrate;
a plurality of semiconductor light sources mounted to each of the at least one substrates, each adjacent semiconductor light source being spaced from each other adjacent semiconductor light source on the substrate to enhance cooling of the semiconductor light sources during operation thereof; and
at least one a transfer device operable to receive light emitted by the semiconductor light sources on the at least one substrate and to transfer the received light to at least one location spaced from the substrate, wherein the transfer device comprises at least one light pipe, each light pipe having a receiving end to receive light emitted from a semiconductor light source and an emitting end to emit the received light.

2. A light engine according to claim 1 wherein the transfer device comprises a light pipe for each semiconductor light source.

3. A light engine according to claim 2 wherein the emitting ends of the light pipes of the transfer device are arranged in a smaller space than the space occupied by the semiconductor light sources on the substrate.

4. The light engine of claim 1 further including at least two substrates, one of said at least two substrates being stacked in front of the other of said at least two substrates and the light pipes of the transfer device extend through the one of said at least two substrates to receive light emitted from the semiconductor light sources on the other of the said least two substrates.

5. The light engine of claim 1 further including at least two substrates wherein one of the at least two substrates is located distal the other of the at least two substrates.

6. The light engine of claim 2 further comprising a forming member to maintain the emitter ends of each light pipe of a transfer device in a desired relationship to the emitter ends of the other light pipes of the transfer device.

7. The light engine of claim 1 wherein at least one light pipe further includes a mixer at its emitter end, the mixer plate diffusing the light emitter from the emitter end.

8. The light engine of claim 2 wherein the forming member is moveable, with respect to the focal point of a headlamp, to alter the beam pattern of the headlamp.

9. The light engine of claim 5 further including a transfer device for each of said at least two substrates, wherein the emitter end of each transfer device is located adjacent the emitter end of each other transfer device.

10. The light engine of claim 2 wherein at least one emitter end of a light pipe in the transfer device has a different shape than another emitter end of a light pipe in the transfer device.

11. The light engine of claim 1 further including a reflector surrounding a semiconductor light source on said substrate to assist in directing light emitted by said semiconductor light source into said receiving end of said light pipe.

12. The light engine of claim 11 wherein each said semiconductor light source is surrounded by a reflector.

13. The light engine of claim 12 wherein the reflectors are formed as a molded part, the molded part assisting the maintaining the receiving ends of the light pipes adjacent the respective semiconductor light sources.

14. The light engine of claim 1 wherein the substrate includes at least one layer of heat transfer material to assist in removing waster heat produced by operation of the semiconductor light sources.

15. The light engine of claim 14 wherein the substrate further includes at least a pair of electrically conductive layers, the semiconductor light sources being powered by electrical current supplied from said pair of electrically conductive layers.

16. The light engine of claim 15 further including at least one additional electrically conductive layer and wherein the semiconductor light sources are arranged into at least two groups, each semiconductor light source in a first of the at least two groups being powered by electrical current supplied from a first pair of electrically conductive layers and each semiconductor light source in a second of the at least two groups being powered by electrical current supplied from a different pair of electrically conductive layers.

17. The light engine of claim 14 wherein the substrate further includes at least two electrically conductive traces, the semiconductor light sources being powered by electrical current supplied from a pair of said at least two electrically conductive traces.

18. The light engine of claim 1 further including at least two transfer devices, the emitter ends of each transfer device being located at a different location than the emitter end of the other of each transfer device.

19. The light engine of claim 1 wherein the automotive lighting system is a headlamp.

20. The light engine of claim 16 wherein the automotive lighting system is a headlamp and a first group of semiconductor light sources forms the low beam pattern of said headlamp and a second group of semiconductor light sources forms the high beam pattern of said headlamp.
